(19) United States
(12) Patent Application Publication
(10) Pub. No.: US 2008/0187603 A1
(43) Pub. Date: Aug. 7, 2008

(54) ARTICLE AND METHOD OF NOVEL ANTIMICROBIAL DELIVERY SYSTEM

(75) Inventor: Reyad I. Sawafta, Greensboro, NC (US)

Correspondence Address: REYAD SAWFTA;QUARTEK CORP., 4180 PIEDMONT PARKWAY, GREENSBORO, NC, 27410, US

(73) Assignee: Quartek Corporation, Greensboro, NC (US)

(21) Appl. No.: 11/868,475

(22) Filed: Oct. 6, 2007

Related U.S. Application Data
(60) Provisional application No. 60/888,343, filed on Feb. 6, 2007.

(51) Int. Cl. A01N 59/00; A01N 59/02; A01N 59/16; A01N 59/20; A01N 59/06; A01P 1/00

(52) U.S. Cl. 424/618; 424/715; 424/600; 424/639; 424/655; 424/646; 424/630; 424/641; 424/649; 424/682; 424/709; 424/722

(57) ABSTRACT

The present invention describes a novel antimicrobial ion delivery system (IDS) article, methods of making the article, and its applications in cleaning dentures and dentistry equipment. The novel IDS entails a source of oligodynamic metal ions embedded in a matrix that allows for the release of metal ions in water at concentrations that are biocidals and prevent biofilm formation. The preferred IDS contains particles made of metallic alloys and bound to a matrix that ensures the controlled release of ions in water. The novel IDS is safe for use in humans and it is environment friendly and biodegradable.

### RELATED APPLICATIONS

This application claims the benefit of U.S. Provisional Applications Nos. 60/888,343 and 60/821,497 and U.S. Patent Application No. 20070087659, that are incorporated by reference into the content application in their entireties.

### FIELD OF THE INVENTION

This invention relates to a novel delivery system of antimicrobials ions for use in cleaning dentures and dentistry equipments. It is further relates to a convenient and self-contained system for cleaning dentures, tooth brushes, endodontotics, and dentistry equipment. The cleaning system is a novel ion delivery system (IDS) that entails a source of oligodynamic metal ions and a matrix that contains this source of metal ions allowing at the same time the controlled release of metal ions in water.

### BACKGROUND OF THE INVENTION

Prevention of oral infections and infections associated with dental practice entails rigorous daily oral hygiene practice as well as control of cross-contamination during routine dental procedures when the possibility of spreading bacterial and viral infections between staff and/or patients is high. Equipment that is not compatible to heat sterilization is either disposable or undergoes chemical disinfection (e.g. formaldehyde, gluteraldehyde) for at least 10 hrs before use. Dental unit water systems (DUWS) are used to irrigate the oral cavity during dental treatment. Water delivered from these devices is not sterile and has been shown to contain high numbers of bacteria (e.g. L. pneumophila, P. aeruginosa, Staphyloccocus spp). Biofilms accumulating on the inner surface of the tubing are responsible for high levels of contamination of DUWS and are more resistant to antimicrobial agents compared to planktonic bacteria. Currently there are no evidence-based guidelines to control bacterial numbers in DUWS. Currently, DUWS, aspirators, and tubes should be cleaned regularly and flushed daily with a non-foaming disinfecting agent. Sometimes the use of harsh agents may be required that leads in time to premature deterioration of tubing and may cause contact allergies. Also, the process of cleaning the DUWS may become time-consuming when it is performed using cocktails of agents (e.g. quaternary amines and oxidizing agents) in a multi-step process. An easy approach to cleaning the DUWS that requires a self-contained cleaning system and a one-step protocol may be of great help in reducing cross-contamination and infection during the routine dental procedures.

Poor oral hygiene is responsible for the vast majority of periodontal disease that consequently lead to an increased risk for cardiovascular disease and other chronic disease. Most frequently encountered microorganisms are A. actinomycetemcomitans, P. gingivalis, P. intermedia, B. forsythus, Campylobacter spp, Eubacterium spp, Fusobacterium spp, enteric gram negative rods, beta hemolytic streptococci, yeast, Eikenella corrodens, Staphylococcus spp, D. pneumosintes, and the herpes virus Cytomegalovirus. These problems occur more frequently in older patients that wear dentures and are incapable of practicing rigorous oral care. In these patients plaque formation is unquestionably a major etiologic factor in the pathogenesis of denture stomatitis, inflammatory papillary hyperplasia, and chronic candidosis. In these patients and moreover in those functionally dependent and cognitively impaired older adults a simple method of cleaning their dentures is of overwhelming importance. Moreover, a self-contained system that would not necessitate the use of several components for cleaning the denture and that could be also used for storing and protecting the denture may be advantageous to these patients.

Mechanical, chemical, and a combination of mechanical and chemical strategies are currently available to patients to facilitate the daily denture hygiene. Denture cleaning generally is carried out daily by soaking dentures in an aqueous cleansing solution that most of the times require also brushing the dentures with a brush. Aqueous denture cleanser solutions are known and generally include tablets or powders that are dissolved in water to form a cleansing bath or cleansing system in water. Tablets and powders for cleansing dentures and the like are well known in the art. A common method for using such a product is to place the denture for a few minutes to several hours in a cleansing bath obtained by dissolving a tablet in water in a cup containing the denture. The aim of a denture cleanser product is to clean the denture and to remove the accumulation of plaque that develops while the denture is being worn. Denture cleansing compositions, such as effervescent tablets and powders, are known and they have a dual action on the plaque such as loosening the debris and bacterial attachment to the denture and killing the exposed cells. Two most popular commercially available alkaline-peroxide soak-type denture cleansers are Efferdent™ and Polident™. Traditionally, these compositions have contained a variety of sulfate salts, such as bisulfates, monopersulfates, and sulfates as detergents, oxidizers and the like, and have also utilized alkali metal and alkaline earth metal halides as bleaches. Such compositions have also included perborate, carbonate and phosphate salts in varying amounts to provide effervescence and activation. Agents such as silicones and fluorocarbon containing polymers that prevent the attachment of bacteria to the clean denture and further development of plaque build-up have also been described in the art.

### SUMMARY OF THE INVENTION

A self-contained article for cleaning dentures and dental equipment is being disclosed. The article is single body article constructed (i.e., unitary construction) from an injection molded plastic such as but not limited to polyethylene, polypropylene, polyethylene terephthalate. Other materials such as but not limited to plastics, polymers, metals, composites, fabrics may also be used. This article contains a novel ion-delivery system (IDS) that in aqueous solutions releases ions that are biocidal to microorganisms responsible for plaque formation in dentures and also contamination of dental equipment.

### BRIEF DESCRIPTION OF THE FIGURES

FIG. 1 Pattern of silver release from various matrices containing AgLi particles placed in water for 24 h. (a) After 24 h water was discarded and matrices (0.5 ug/ml AgLi) placed in fresh water for additional 24 h; the study consisted of 5 refill cycles. (b) Matrices loaded with 0.5, 5, and 10 ug/ml AgLi were placed in water for cycles of 24 h; values were measured after the 2^{nd} refill with fresh water.

FIG. 2 The biocidal effect of particle-containing polymeric coupon. Particles are AgLi particles embedded in an EVA polymeric matrix and tested in water at (a) 100 ug/ml AgLi across pathogens; (b) 1 ug/ml against E. coli.

FIG. 3 Longevity of the biocidal effect of an IDS comprising AgLi particles embedded in an EVA polymeric coupon. Experiments were performed in (a) water; (b) media.

FIG. 4 The effect of an IDS comprising AgLi particles embedded in an EVA polymeric coupon in preventing biofilm formation.

FIG. 5 The biocidal effect of particle-containing polymeric coupons. Particles are AgLi particles embedded in various polymeric materials such as (a, b) PVMK; (c) methyl methacrylate; and (d) dental resin.

FIG. 6 The biocidal effect of an IDS consisting of AgLi deposited inside a polystyrene cup.

FIG. 7 The biocidal effect of particle-containing polymeric coupon. Particles are AgLi particles embedded in a polyurethane foam and tested in water at (a) 0.1 mg/ml; (b) 2 mg/gal.

FIG. 8 Longevity of the biocidal effect of an IDS comprising AgLi particles embedded in a polyurethane foam. Experiments were performed in (a) water; (b) media.

FIG. 9 The biocidal effect of particle-containing polymeric coupon. Several classes of particles were embedded in a polyurethane foam and tested in water at 1 mg particles/gal; (a) AgLi; (b) AgCuLi; (c) AgCu.

FIG. 10 The biocidal effect of a dual system comprising a particle-containing foam and 0.5 ppm chlorine. Particles are AgLi particles embedded in a polyurethane matrix and tested in water in 5 gal of water containing or not chlorine. (a) The effect of charged water on E. coli after 24 h from adjusting the chlorine level to 0.5 ppm; (b) The effect of 24 h-charged water on E. coli immediately after re-adjusting the chlorine level to 0.5 ppm.

FIG. 11 The biocidal effect of particle-containing polymeric films across pathogens. Particles are AgLi particles embedded in a PVA/Chitosan film and tested in media at 50 ug/coupon.

FIG. 12 The biocidal effect of particle-containing paper across pathogens. Particles are AgLi particles embedded in paper coupons and tested in media at 50 ug/coupon.

FIG. 13 The longevity of the biocidal effect of a IDS comprising AgLi particles embedded in paper coupons at various concentrations. Experiments were performed in media.

FIG. 14 Longevity of the biocidal effect of particle-containing woven fabric. Particles are AgLi particles embedded in the fabric at 50 ug/in².

FIG. 15 Longevity of the biocidal effect of particle-containing non-woven fabric. Particles are AgLi particles embedded in the fabric at 200 ug/in²

### DESCRIPTION OF THE INVENTION

The present invention describes a novel IDS that comprises a source of metal ions with biocidal properties and a matrix that immobilizes the source of ions and provides a sustained release of ions at biocidal concentration. The main purpose of such biocidal IDS is water disinfection, although other applications such as food packaging, preservation, personal care, construction, agriculture, biodefense and others are not excluded.

As used herein the terms “particles” refer to metallic particles but also to salts and any particulate materials than can be a source of metal ions.

As used herein, the terms “comprise,” “comprising,” “include,” and “including” are intended to be open, non-limiting terms, unless the contrary is expressly indicated.

As used herein, the term “composition” is intended to be used for alloys that have two or more elements or combinations of alloys that are produced by a preferred technique as described herein and has preferred biocidal properties and they have a size above 5 nm.

As used herein, the terms “biocidal”, “nanocidal”, “biocidal nanoparticles” are intended to be used as antimicrobial, antibacterial, antifungal, anti algae, antiviral, and other pathogenic organisms. The broad biocidal spectrum includes Gram + and Gram − bacteria, spore and non-spore forming bacteria, viruses, vegetative and non-vegetative fungi, yeast, protozoa, and other microorganisms.

As used herein, the terms “nanocomposites”, “nanoparticles”, “particles” and “nanomaterials” are intended to be used for structure of any shape and composition with dimensions between 0-2000 nm.

As used herein, the term “denture” is intended to be used for any removable device that is manufactured fro placement within the mouth and can be temporarily removed as a whole of a fraction for the purpose of cleaning and hygienic treatment.

As used herein, the term dentistry equipment is intended to refer to any hardware used within the dentist clinic or office and requires antimicrobial or hygienic treatment due to exposure to patients and or clinic personnel.

The invention provides a method making an article for cleaning dentures and dentistry equipment. The disclosed article comprises:

1. A container made (i.e., unitary construction) from an injection molded plastic such as but not limited to polyethylene, polypropylene, polyethylene terephthalate. Other materials such as but not limited to plastics, polymers, metals, composites, fabrics may also be used. This container accommodates compositions that provide the antimicrobial effect against microorganisms that colonize dentures as well as dental equipment (i.e., DUWS). This container may also be designed to carry an antimicrobial effect by the means of coating (e.g. imprinting, spray coating) its walls with the further disclosed antimicrobial agent.
2. A novel delivery system (DS) consisting of a source of metal ions and a matrix containing this source of metal ions and that releases metallic ions with biocidal properties in aqueous environment.
(a) The ion delivery system (IDS) comprises a source of metal ions such as but nor limited to metal salts, uni-element metal particles, and multi-element alloyed metal particles. The metal ion yielding material may be a metallic salt or mixture of metallic salts, metallic particles or mixture of metallic particles, or a mixture of metallic salts and metallic particles. In a preferred embodiment of the invention the metal ion yielding material will consist of particles made of metallic alloys compositions with superior antimicrobial properties as described in US Pat. Appl. 20070087659.
(b) The metal ion source is embedded in an environment-friendly matrix that allows the release of ions in a controlled manner in aqueous environment. Preferred matrices are polymeric structures. The term “polymeric” is understood to mean that the composition comprises one or more monomers, oligomers, polymers, copolymers, or blends thereof. Other potential matrices to bind the metallic particles are cellulose materials (e.g. paper, cardboard) and textiles (e.g. woven and non-woven).

We claim that the described cleaning article may be manufactured as a disposable or rechargeable article. We claim multiple applications for the cleaning article described herein such as but not limited to cleaning denture and cleaning dental equipment (e.g. DUWS). Additional use may be storage and protection of dentures or equipment in between uses. We also claim the use of the IDS in conjunction with other antimicrobial or cleaning agents such as but not limited to oxidizing agents and effervescent agents, as required by the application.

The source of metal ions. Metal ions with antimicrobial properties, such as silver, copper, zinc, and others are obtained by dissolving the corresponding metal salts in water or by the release of ions from their metallic sources. Preferred metal salts used to readily yield metal ions are halides, nitrates, sulfates, carbonates, silicates, oxides, and hydroxydes. These salts can be used as alone or in combination when they are incorporated in the matrix of choice. When longevity of the biocidal effect provided by the IDS described herein is desired, the preferred source of metal ions is represented by metallic particles. Various classes of metallic particles with strong biocidal properties against bacteria, fungi, and viruses have been described in our US Pat Appl. 20070087659. Different classes of particles have been produced by varying the elemental composition of the alloys, the elemental ratios within the same alloy, or by changing parameters in the synthesis process. As needed, these particles may be synthesized in various size ranges from 5 nm to 2000 nm, and preferred under 1000 nm, and most preferred between 100 nm and 300 nm. In one embodiment particles made of two or more element alloys have superior biocidal properties compared to one element particles. In one embodiment a combination of transition metals 3d of the periodical table such as Chromium or Manganese or Iron or Cobalt or Nickel or Copper or Zinc or 4d Silver or 5d Gold, or rare earth metals from the lanthanides such as Cerium, or Neodymium, or Samarium, or Gadolinium, or Terbium, or Dysprosium, or Holmium, or Erbium, or alkali metals such as Lithium, or Sodium, or Potassium, or Magnesium, or Calcium in a binary or tri or quad combination with different percentages will compose a preferred biocidal nanoparticle class. In one preferred embodiment, a composition is synthesized where Silver is a dominant element in the composition of the form AgₐM_{b}N_{c}Q_{d}, where a, b, c, and d are the proportion of the elements in the composition of the nanoparticles. (M), (N) and (Q) are other elements used in the composition. In a preferred sub-embodiment, (M) can be one of the following metals, Chromium or Manganese or Iron or Cobalt or Nickel or Copper or Zinc or Gold, or a rare earth material such as Cerium, or Neodymium, or Samarium, or Gadolinium, or Terbium, or Dysprosium, or Holmium, or Erbium, or Lithium. (N) can be any one of the elements described above under (M) but also Silver. (Q) can be any one of the elements described above under (M) but also Silver. In this composition, a is ranging from 50-99.7%, b ranging from 0.1-49.8%, c ranging from 0.1-49.8% and d ranging from 0.1-49.8%.

In another preferred sub-embodiment the composition have three elements in the composition where Silver remains the dominant element in the composition in the form AgₐM_{b}N_{c}. In a preferred sub-embodiment, (M) can be one of the following metals, Chromium or Manganese or Iron or Cobalt or Nickel or Copper or Zinc or Gold, or a rare earth material such as Cerium, or Neodymium, or Samarium, or Gadolinium, or Terbium, or Dysprosium, or Holmium, or Erbium, or Lithium. (N) can be any one of the elements described above under (M) but also Silver. In this composition, a is varying from 50%-99.8% and b is varying from 0.1%-49.9% and c is varying from 0.1-49.9%.

In another preferred sub-embodiment where the composition have two elements where Silver is a dominant element in the form AgₐM_{b} where (M) can be one of the following elements, Chromium or Manganese or Iron or Cobalt or Nickel or Zinc or Gold, or a rare earth material such as Cerium, or Neodymium, or Samarium, or Gadolinium, or Terbium, or Dysprosium, or Holmium, or Erbium, or Lithium. In this composition, a is varying from 50-99.9% and b is varying from 0.1-50%.

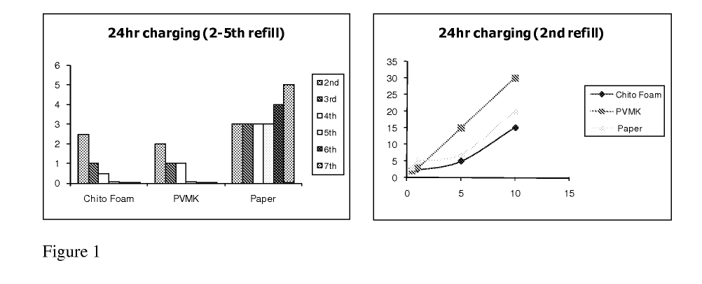

The matrix. The source of metal ions is immobilized in a matrix and the efficient release of ions depends on parameters such as metal salt concentration and solubility, particle size, concentration, and density in the matrix, and their interaction with water. The latter property is dictated by the hydrophilic nature of the matrix as well as its 3-D structure. The manner in which silver as an example of a metal ion with biocidal properties is released from various particle-containing matrices is presented in FIG. 1.

In one embodiment, the composition of the IDS includes a polymeric material. The term “polymeric” is understood to mean that the composition comprises one or more monomers, oligomers, polymers, copolymers, or blends thereof. Examples of polymers include polyvinyl alcohol, poly ethylene glycol, ethyl cellulose, polyolefins, polyesters, nonpeptide polyamines, polyamides, polycarbonates, polyalkenes, polyvinyl ethers, polyglycolides, cellulose ethers, polyvinyl halides, polyhydroxyalkanoates, polyanhydrides, polystyrenes, polyacrylates, polymethacrylates, polyurethanes, polypropylene, polybutylene terephthalate, polyethylene terephthalate, nylon 6, nylon 6,6, nylon 4,6, nylon 12, phenolic resins, urea resins, epoxy resins, silicone polymers, polycarbonates, polyethylene vinylacetate, polyethylene ethyl acrylate, polylactic acid, polysaccharides, polytetrafluoroethylene, polysulfones and copolymers and blends thereof.

In one embodiment the polymeric material is biocompatible, and preferably biodegradable. Examples of suitable polymers include ethylcelluloses, polystyrenes, poly(ε-caprolactone), poly(d,l-lactic acid), polysaccharides, and poly(d,l-lactic acid-co-glycolic acid). The polymer is preferably a copolymer of lactic acid and glycolic acid (e.g., PLGA, PVA or Chitosan).

Other suitable matrices for particles are cellulose materials such as paper and cardboard or fabrics (woven or non-woven) to which particles are optionally bound using specific binders as described below.

Methods of making the IDS. This invention discloses methods of making the antimicrobial IDS article. The size and shape of the final delivery system may vary as required by the application. For example, polymeric matrices containing particles may be presented as foams (open or closed-cell foam), films, or discs. Particles are added into the matrix at a concentration determined by the targeted load in the final product. It is disclosed in this application that the uniform dispersion of particles in the matrix is achieved using dispersant agents such as surfactants and most preferably ionic liquids (ILs). The most preferred ILs are those derived from imidazolium salts, and among which the most preferred is 1-propyl-3-methylimidazolium (PMI). In the presence of PMI an aqueous suspension of metallic particles remains in a stable colloidal state, disperses uniformly in the matrix, and improves the particle loading capacity of the matrix.

In one embodiment of the invention particles are uniformly mixed with the matrix (e.g. polymeric mix, paper slurry) and then the mixture processed (e.g. casting, extrusion, co-extrusion, heat pressing) at determined temperatures. Alternatively, the matrix can acquire the particle load by spraying, coating, in situ particle synthesis, or submersion in a suspension of particles followed by drying. In those cases where the IDS consists of a combination of matrices, the addition of particles may be part of a multi-step process. For example, a polymeric foam containing particles may constitute an IDS on its own, or it may contain an additional matrix containing particles. This latter matrix (e.g dried pulp, polymeric film, fabric) may be added to the polymeric foam in various ways. First, a grafting method could be used where the polymeric mix of the foam is cast in situ onto a coupon/layer/sheet of the secondary matrix prepared a priori. The new IDS may have the secondary matrix partially or totally enclosed in the polymeric foam. Second, a coupon/layer/sheet of the secondary matrix that contains particles could be inserted in a preformed polymeric foam that presents pockets or slots to accommodate additional matrices.

The approaches in which the IDS may be made are briefly presented below. Variations of the procedures briefly described below should be evident to those skilled in the art.

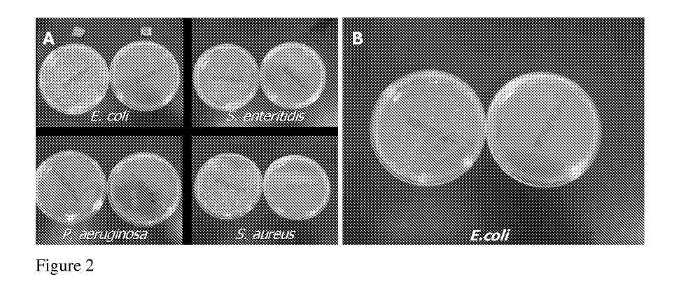

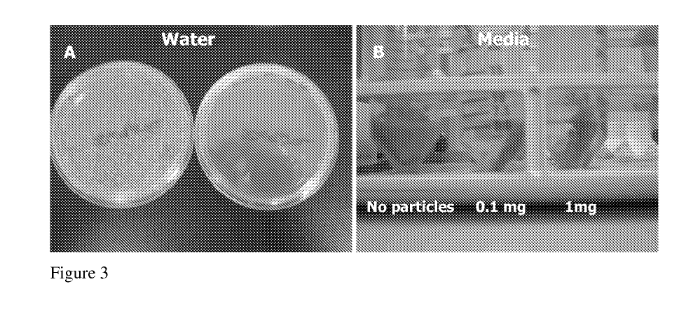

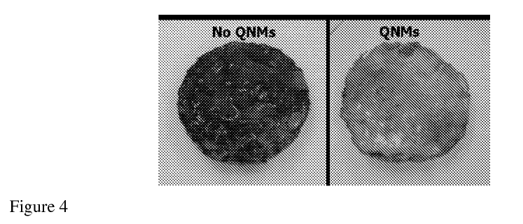

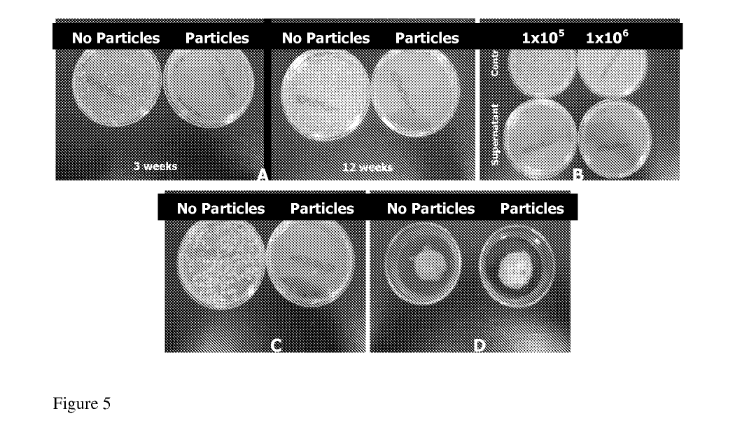

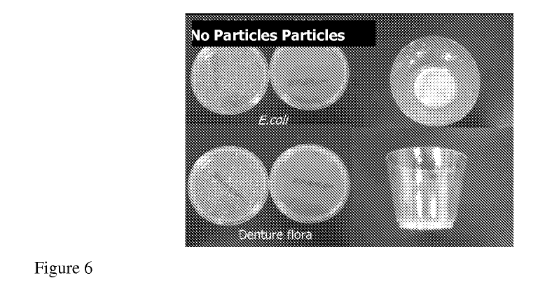

Polymeric coupons (FIGS. 2-6). Particles are mixed in the polymeric melt (e.g. EVA, PVA, polysterene) and then molded under the desired shape or size. Alternatively, Particles can be deposited on the surface of a polymeric surface by means of spraying, coating, imprinting, or in situ deposition.

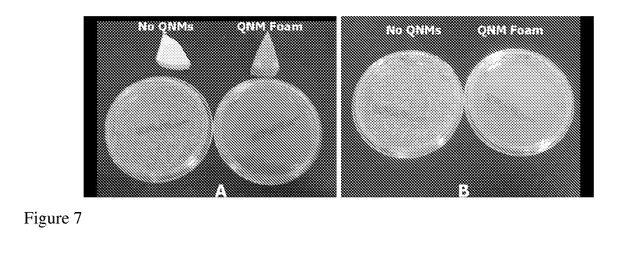

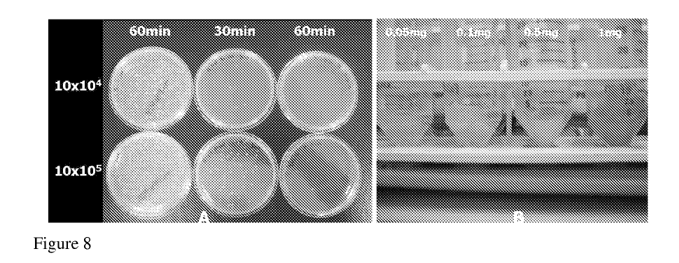

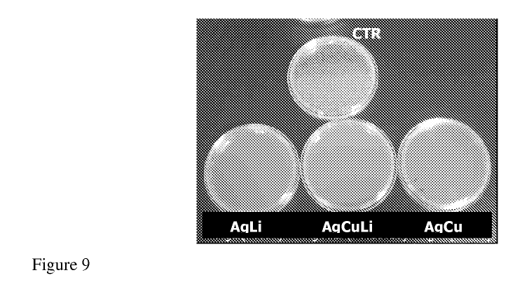

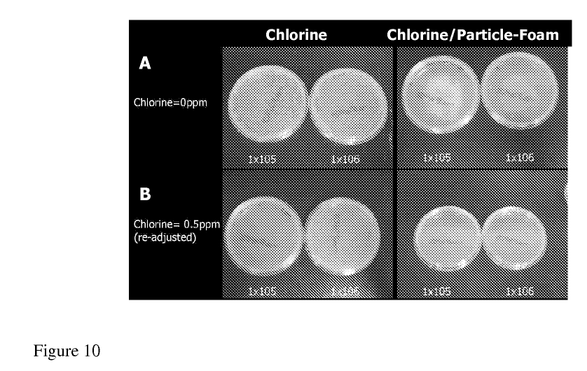

Polyurethane foam-based IDS (FIGS. 7-10). One preferred foam matrix is polyurethane-based which is obtained through a process that comprises a mixture of polymers (e.g. PVA, Chitosan), isocyanates (e.g. toluene diisocyanate, methylene diphenyl diisocyanate), polyols (e.g. polyethers and polyesters), and organometallic catalysts (e.g. dibutyltin dilaurate and stannous octoate). The most preferred polyurethane composition uses the natural polyol castor oil and a decreased amount of isocyanate to obtain foam that is more environmental friendly.

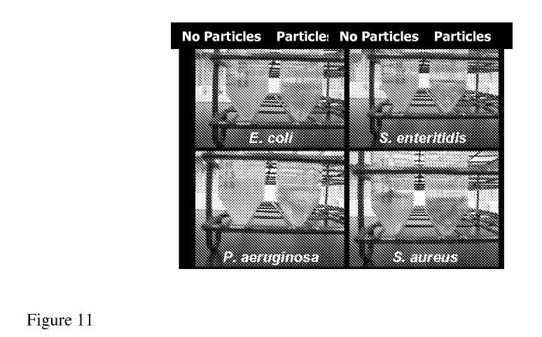

Polymeric films-based IDS (FIG. 11). Depending on the application, films composition may include one or more polymers (e.g. PVA, chitosan, HPMC), crosslinkers (e.g. gluteraldehyde, UV and heat curing), plasticizers (e.g. glycolates, citrates, ionic liquids), and colorants. Particles are blended in the film composition and the films prepared by casting or extrusion at room temperature or under heat conditions.

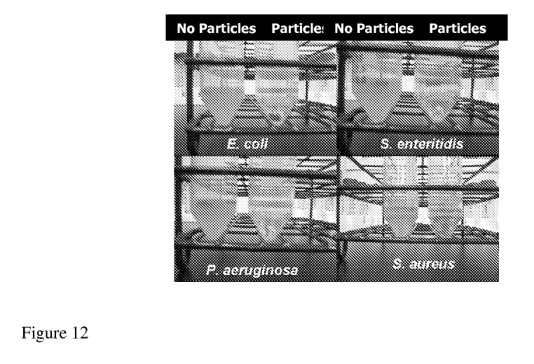

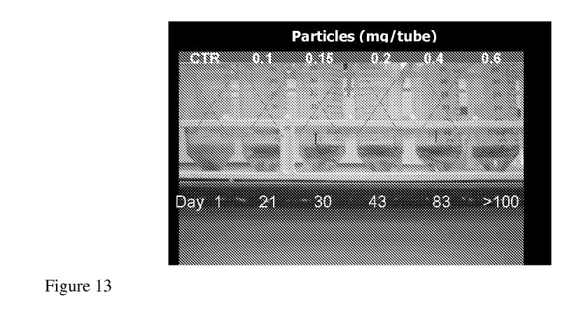

Paper or cardboard-based IDS (FIGS. 12 and 13). First, particles are mixed with the optional substances known in the papermaking industry such as sizing agents, retention aid polymers, binders, fillers, etc. Examples of sizing agents are from the groups of rosin, alkyl ketene dimmers, or alkenyl succinic anhydride (ASA). Retention aids can be from the groups of coagulation, flocculation, and entrapment agents. Examples of binders include but are not limited to PVA, carboxymethylcellulose, starch and modified starch, polyacrylamide and modified polyacrylamide, acrylate and methacrylate, polyols and modified polyols, glycoxal and glycoxal urea, diisocyanate and diisocynate compounds, and resins. Then the particles-chemicals mix is added to the watery pulp that may or may not have undergone bleaching. After stirring, the mix is then poured into the mold, drained, and then sent to the paper machine.

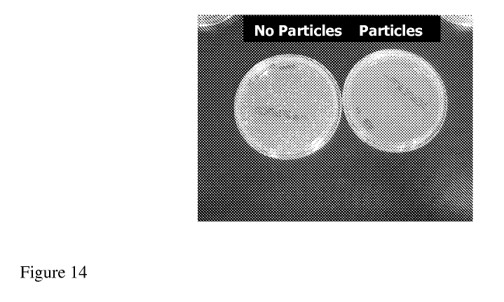

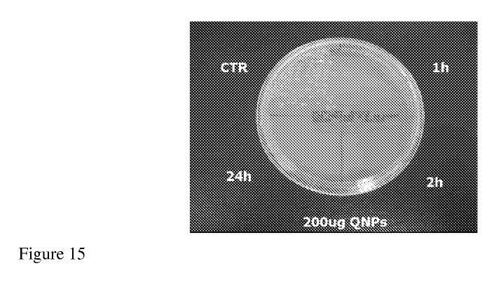

Fabric (woven and non-woven)-based IDS (FIGS. 14 and 15). Particles can be added to the fiber before or after extrusion or to the fabric itself during the finishing stages. A binder material that adheres the particles to the target yarn and/or fabric surface provides highly beneficial durability for the yarns. Preferably, this component is a polyurethane-based binding agent, although other types, such as a permanent press type resin or an acrylic type resin. The selected substrate may be any fabric comprising individual fibers or yarns of any typical source for utilization within fabrics, including natural fibers (cotton, wool, ramie, hemp, linen, and the like), synthetic fibers (polyolefins, polyesters, polyamides, polyaramids, acetates, rayon, acylics, and the like), and inorganic fibers (fiberglass, boron fibers, and the like) or combination of thereof. The target fabrics may be of any standard construction, including knit, woven, or non-woven forms. The uniform distribution of beads in the yarn/fabric is achieved by submersing the material in an aqueous solution of particles. Subsequently, particle-impregnated material is removed from the solution and dried.

Methods of Using the Ion Delivery System (IDS). This invention discloses potential applications of the antimicrobial IDS article in water disinfection. Depending on the application, IDS may be disposable or reusable. Disposable IDS will have a determined amount of particles bound to the matrix and it will be discarded once the ion discharge and therefore the antimicrobial effect are consumed. In the case of reusable DS, the final article will be designed to accommodate inserts (e.g. slots or pockets) containing particles bound to various matrices. In this case not only that the final IDS article is reusable, but it can also be loaded with various doses of biocidal agent as required by the contamination conditions (e.g. treatment of heavy microbial load vs. maintenance or preventive treatment). Also the latter scenario can facilitate a multi-treatment session where in each slot/pocket various biocidal agents are loaded (e.g. metal ion yielding insert and sodium chlorite load for disinfection of recreational waters, or metal ion yielding insert and citric acid load for cleaning of dental water unit).

Generally, the method includes placing the biocidal IDS article having a selected composition at a site intended for water disinfection and preservation (e.g. recreational water, dental water units) or treatment and prevention (e.g. antiseptic for wounds, lesions, oral care).

1. A novel delivery system of antimicrobials ions for use in cleaning dentures and dentistry equipments

2. Said antimicrobials in claim 1 are but not limited to the following materials used on its own or in combinations
a. Metal salts such as but not limited to chlorides, sulfates, carbonates
b. Metal particles in bi, tri or quaternary element compositions
c. Particulate metallic alloys in bi, tri or quaternary and combination thereof, which is the most preferred source of metal ions

3. Said ionic antimicrobial in claim 1 in its own or in combination has a magnetic moment

4. Said ionic antimicrobial in claim 1 in its own or in combination posses a unique color or transparent

5. Said ionic antimicrobial in claim 2 have size varying from 5 nm to 2000 nm, preferred under 1000 nm, and most preferred between 100 nm and 300 nm.

6. Said metal and metal alloy particles in claim 2 are maintained in a stable colloidal suspension using dispersant agents such as but not limited to surfactants and most preferably ionic liquids (ILs). The most preferred ILs are those derived from imidazolium salts, and among which the most preferred is 1-propyl-3-methylimidazolium.

7. Said metal particles in claim 2 are in the form of binary, trinary and quaternary element alloy compositions with variations based on weight of each of the elements with a percentage by weight that covers a range of 5% up to 95% for each of the elements in the composition.

8. Said metal particles in claim 2 have a quaternary element alloy compositions in the form LₐM_{b}N_{c}Q_{d}, where (L) is a metal that has a dominant percentage in the formulation. (L) is one of the following metals, Chromium or Manganese or Iron or Cobalt or Nickel or Copper or Zinc, or Silver or Gold, or a rare earth material such as Cerium, or Neodymium, or Samarium, or Gadolinium, or Terbium, or Dysprosium, or Holmium, or Erbium, or Lithium or Sodium, or Potassium, or Magnesium, or Calcium. (M) is one of the elements described above under (L) but except the dominant element for the specific combination. (N) is one of the elements described above under (L) including the element that is dominant for the specific combination but except the element in (M). (Q) is one of the elements described above under (L) including the element that is dominant for the specific combination but except the element in (N). The proportion of elements in each composition is indicated by a, b, c, and d where a can vary from 26%-99.7%, b can vary from 0.1-49.8%, c can vary from 0.1-49.8% and d can vary from 0.1-49.8%.

9. Said preferred quaternary element compositions described in claim 8 are AgCuCoLi, AgCuZnLi, AgCoZnLi, AgCuCoZn, and combinations thereof.

10. Said metal particles in claim 2 have a trinary element alloy composition in the form of Lₐ,M_{b} N_{c} where (L) is the dominant element in the composition. (L) is one of the following metals, Chromium or Manganese or Iron or Cobalt or Nickel or Copper or Zinc, or Silver or Gold, or a rare earth material such as Cerium, or Neodymium, or Samarium, or Gadolinium, or Terbium, or Dysprosium, or Holmium, or Erbium, or Lithium. (M) is one of the elements described above under (L) but except the dominant element for the specific combination. (N) is one of the elements described above under (L) including the element that is dominant for the specific combination but except the element in (M). The proportion of elements in each composition is indicated by a, b, and c where a can vary from 3450%-99.8%, b can vary from 0.1-49.9%, c can vary from 0.1-49.9%.

11. Said preferred tri element compositions described in claim 10 are AgCuCo, AgCuNi, AgCuLi, AgZnCu, CuAgLi, CuCoAg, CuCoZn, CuCoLi, CuZnAg, ZnAgCu, ZnCuLi, ZnAgLi, ZnCoLi and combinations thereof.

12. Said metal particles in claim 2 have a binary element alloy composition in the form of Lₐ,M_{b} where (L) is the dominant element in the alloy composition. (L) is one of the following metals, Chromium or Manganese or Iron or Cobalt or Nickel or Copper or Zinc, or Silver or Gold, or a rare earth material such as Cerium, or Neodymium, or Samarium, or Gadolinium, or Terbium, or Dysprosium, or Holmium, or Erbium, or Lithium. (M) is one of the elements described above under (L) but except the dominant element for the specific combination. The proportion of elements in each composition is indicated by a and b, where a can vary from 50%-99.9%, b can vary from 0.1-50.

13. Said preferred binary element compositions described in claim 12 are AgCu, CuAg, ZnCu, CuZn, AgZn, ZnAg, NiCu, CuNi, AgLi, LiAg, CuLi, LiCu, and combinations thereof.

14. Combinations of compositions mentioned in claims 8, 10, and 12 are preferred.

15. Said metal salts in claim 2 may be present in the ionic delivery system as salts alone or in combination of two, three, or multiple salts.

16. Said metal salts in claim 2 may have in their composition metals with antimicrobial properties such as but not limited to Ag, Cu, Co, Zn, Ni, and Li

17. Said metal salts in claim 2 may be from the class of but not limited to halides, nitrates, sulfates, carbonates, silicates, oxides, and hydroxydes.

18. Said metal particles in claim 2 may have in their composition one of the metals with antimicrobial properties such as but not limited to Ag, Cu, Co, Zn, Ni, and Li.

19. Ionic antimicrobial agents are released from the source in said claim 2 is a metal ion or a mixture of metal ions with oligodynamic properties such as, but not limited to Ag, Cu, Co, Zn, Ni, and Li.

20. The carrier for the ionic antimicrobial agents in claim 1 is a material that allows the interaction between the metal ion source and water and the controlled release of the ionic antimicrobial agents in water.

21. Said carrier in claim 20 can be in forms such as but not limited to open-cell and closed-cell polymeric foams, soft polymeric films, flexible and rigid discs, cardboard, paper, napkins, wipes, tissues and fiberglass, and woven and non-woven fabric materials.

22. Said carrier in claim 20 contains the metal ion source as an integral part blended in its composition or as a renewable insert.

23. Said carrier in claim 20 that contains the metal ion source blended in its composition is discarded after the consumption of the antimicrobial properties.

24. Said carrier in claim 20 that contains the metal ion source as an insert is reusable upon the replacement of the insert loaded with metal ion source.

25. Said ionic delivery system for dentures and dentist equipment disinfection in claim 1 can be used alone or in combination with other biocidal/biostatic agents.

26. Said ionic delivery system for dentures and dentists equipment disinfection in claim 1 can be used alone or in combination with other biocidal/biostatic agents in residential and office settings, industrial or dental/medical or military settings, outdoor (e.g. recreational water) and indoor, food packaging, cosmetics, and finally for human or animal use.

27. Said ionic delivery system in claim 1 is nontoxic and eco-friendly.
